(19) United States
(12) Patent Application Publication
(10) Pub. No.: US 2009/0244298 A1
(43) Pub. Date: Oct. 1, 2009

(54) Imaging device and image capture device

(75) Inventors: Tiegang Liu, HuNan Province (CN); Sio Kuan Lam, Sheung Shui (HK); Wing Ming Fan, Sheung Shui (HK); Kin Ming Fan, Ma Wan (HK); Kwok Sing Cheng, Tuen Mun (HK)

Correspondence Address: BERKELEY LAW & TECHNOLOGY GROUP, LLP, 17933 NW Evergreen Parkway, Suite 250, BEAVERTON, OR, 97006, US

(73) Assignee: Hong Kong Applied Science and Technology Research Institute Co., Ltd., New Territories (CN)

(21) Appl. No.: 12/383,412

(22) Filed: Mar. 24, 2009

(30) Foreign Application Priority Data
Mar. 26, 2008 (CN) CN 200810087025.4

(51) Int. Cl. H04N 5/228

(52) U.S. Cl. 348/208.4; 348/222.1; 348/E05.031

(57) ABSTRACT

The invention discloses a imaging device, comprising an imaging module, used for optical to electrical signal conversion, which comprises at least a first imaging unit and a second imaging unit, the first imaging unit used for capturing an image, the second imaging unit used for detecting the movement of the image or the imaging device; a control and processing module, used for controlling the imaging module to output electrical signals, and for processing the electrical signal to generate and to output the motion signal and image signal. The invention also discloses an image capture device which uses the said imaging device. The imaging device can output the motion signal and the image signal simultaneously by adding the second imaging unit used for detecting the movement of the image or the imaging device; consequently better captured image quality can be obtained. Also, the structure can become simpler and the manufacture cost can be lower.

### TECHNICAL FIELD

The invention relates to optical device, and particularly to an imaging device and image capturing device

### BACKGROUND—PRIOR ART

Optical sensor technology develops rapidly, especially for the optical image sensor for image capturing application. Also, some image sensors are engineered for detecting image motion. The existing optical sensors for motion detection are disclosed by U.S. Pat. No. 7,209,601B2 and U.S. Pat. No. 7,271,830B2. U.S. Pat. No. 7,209,601B2 discloses an image sensor, which comprises an imaging pixel array for motion detection. U.S. Pat. No. 7,271,830B2 discloses a motion detection method, which comprising the following: comparing a current image frame to one or more previous image frame, and determining whether the motion difference between the current image and the past image frame is below the predetermined threshold value, if the difference is below the predetermined threshold value the current image frame will be seen as the stable status, and the current image frame will be saved as final image. The sensor and method described above use software executed on a processor to compare the same pixel array's output image to find out the motion of the image of the image capturing device, and belong to the software motion detection. Another U.S. publication U.S. 2007/0103555A1 discloses a mobile phone imaging device which implements the motion detection by including one or more gyroscopes. Because of the need of including the gyroscope, the product will have a rather complex structure and high cost.

### SUMMARY

An object of the example embodiments described herein is to provide an imaging device which can implement a precise sub-frame motion detection. The imaging device may be an imaging sensor. Another object of the embodiments described herein is to provide a simple structure and low cost image capturing device for the implementation of the precise sub-frame motion detection. In accordance with claimed subject matter, the embodiments provide an imaging device comprising an imaging module, used for optical to electrical signal conversion, which comprises at least a first imaging unit and a second imaging unit, the second imaging unit used for detecting the movement of the image or imaging device, the first imaging unit used for capturing an image; a control and processing module, used for controlling the imaging module to output electrical signals, and for processing said electrical signals to generate and to output a motion signal and an image signal.

Said first imaging unit comprises an imaging pixel array for capturing the image signal, said second imaging unit comprises one or more imaging pixel sub-arrays; said imaging pixel sub-arrays are all used for capturing the motion signal, or all used for capturing the motion signal and the image signal simultaneously, or the second imaging unit comprises an imaging pixel sub-array used for capturing the motion signal and imaging pixel sub-array used for capturing the motion signal and image signal simultaneously.

Said first imaging unit and the said second imaging unit are implemented in the same imaging pixel array; and the imaging pixel arrays are divided into many regions, a region thereof is used for capturing the image signal, and the other regions are used for capturing the motion signal, or all regions are used for capturing the motion signal and image signal simultaneously; or the imaging pixel array comprises a region for capturing motion signal and also a region for capturing the motion signal and image signal simultaneously.

Said control and processing module comprises: an image processing unit, used for processing the electrical signal outputted by the said first imaging unit to generate the image signal; a motion detection unit, used for processing the electrical signal outputted by the said second imaging unit to generate the motion signal; and a control unit, used for controlling said first imaging unit, said second imaging unit, said image processing unit and said motion detection unit to work corporately.

Said first imaging unit and the said second imaging unit are set closely in the surface of the same imaging chip. The sampling frame rate of the said first imaging unit is lower than the sampling frame rate of said second imaging unit. The pixel size and pixel amount of said first imaging unit and said second imaging unit is the same or different.

Embodiments of the invention also provide an image capturing device of said imaging device, which comprises: an imaging module, used for optical to electrical signal conversion, which at least comprises a first imaging unit and a second imaging unit, the second imaging unit is used for detecting the movement of the image or imaging device, the first imaging unit is used for capturing image; a control and processing module, used for controlling the imaging module to output electrical signals, and for processing the said electrical signals to generate and to output the motion signal and image signal; an optical lens, used to produce an image of the photographed object at the imaging module;

and an execution module, used for carrying out a relevant movement of the optical lens unit in response to the said motion signal and the image signal.

The execution module comprises an execution control unit and a three dimensions execution mechanism, the execution control unit is used for sending out a motion control instruction according to the motion signal and image signal, the three dimensions execution mechanism is used for drive the object being executed to move in three dimensions according to the motion control instruction.

The motion control instruction is the control instruction for controlling the movement of the optical lens unit to realize the anti-shake compensation. Said first imaging unit and the said second imaging unit are set closely in the surface of the same imaging chip. The sampling frame rate of said first imaging unit is lower than the sampling frame rate of said second imaging unit.

The pixel size and pixel amount of said first imaging unit and said second imaging unit is the same or different. The intended advantageous effects of the embodiments are as follows:
1) The imaging module of the invention comprises at least a first imaging unit and a second imaging unit, the first imaging unit captures image, the second imaging unit detects the movement of the image or imaging device; the control and processing module processes the electrical signals outputted by the first and second imaging unit to generate and output the motion signal and image signal; the execution module executes the relevant movement to regulate element being executed in response to the motion signal and the image signal. For the image capturing device which uses the imaging module, the element on which movements are executed is the optical lens. After the image capturing device does the motion detection through the imaging module, the execution mechanism drives the optical lens to implement the anti-shake compensation. Compare with the prior art, the embodiments of invention not only comprise the first imaging unit used for capturing image, but also the second imaging unit used for detecting movement. The first and second imaging units have different sampling rates, so that the Sub-Frame Motion Detection function can be implemented.
2) The imaging module of the invention only adds one or more imaging pixel arrays to the existing imaging device. The structure of each pixel array is basically identical with the common imaging device. Alternative the embodiments of the invention do not add an imaging pixel array, but divides a single array into different imaging regions with different functions. So the process art, technology and material for producing common imaging device can be used in the imaging module of the embodiments.
3) Compared with the existing solution which's motion detection device using gyroscope and acceleration detection instrument, the embodiments can simplify the structure and bring down the cost.

### BRIEF DESCRIPTION OF THE DRAWINGS

These and other objects and advantages of the present invention will become readily apparent to those skilled in the art upon reading the following detailed description and claims and by referring to the accompanying drawings.

FIG. 1 is a system block diagram illustrating one embodiment of the invention's imaging device;

FIG. 2 is a system block diagram illustrating another embodiment of the invention's imaging device;

FIG. 3 is a system block diagram illustrating another embodiment of the invention's imaging device;

FIG. 4 is a system block diagram illustrating one embodiment of the invention's image processing device and image capture device;

FIGS. 5a and 5b is a function diagram illustrating the invention's sub-frame motion detection.

### DETAILED DESCRIPTION

The present invention is more specifically described in the following paragraphs by reference to the drawings attached only by way of example.

The invention's imaging device comprises the imaging module, the control and processing module, the imaging module at least comprises the first imaging unit and the second imaging unit. The first imaging unit is used for capturing images; the second imaging unit is used for detecting the movements of the images or the imaging device. The detected movement information comprises the movement's direction, displacement and etc. The first and second imaging units convert the collected optical signals to corresponding electrical signals. The control and processing module controls the first and second imaging unit's outputted electrical signals, and processes them to generate the motion signal and image signal. The motion signal reflects the result of the motion detection, and used for controlling the execution module to carry out the relevant movement, and regulating the status of the element on which the movements are executed.

The first imaging unit comprises an imaging pixel array for capturing the image signal; the second imaging unit comprises one or more imaging pixel arrays. In different embodiments, the second imaging unit's imaging pixel arrays are all used for capturing the motion signal, or all used for capturing the motion signal and the image signal. Alternative the second imaging unit comprises some imaging pixel arrays used for capturing motion signal and also some imaging pixel arrays used for capturing motion signal and image signal.

As an improvement, the first imaging unit and second imaging unit are implemented in the same imaging pixel array. The imaging pixel array is divided into many regions. In different embodiments, a region is used for capturing the image signal, and the other regions are used for capturing the motion signal; or the regions are all used for capturing the motion signal and the image signal. Or the imaging pixel array comprises the region for capturing the motion signal and also the region for capturing the motion signal and the image signal.

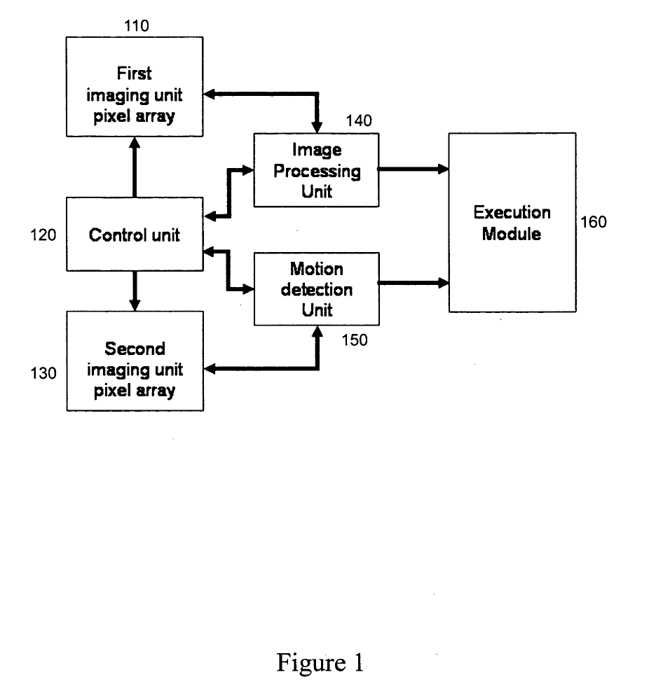

Please refer to FIG. 1, in an embodiment of the imaging device, the control module comprises the image processing unit 140, motion detection unit 150 and control unit 120. The imaging module comprises the first imaging unit 110 and the second imaging unit 130. The first imaging unit 110 comprises the first imaging pixel array; the second imaging unit 130 comprises the second imaging pixel array. The signal output port of the first imaging pixel array is connected to the image processing unit 140; the signal output port of the second imaging pixel array is connected to the motion detection unit 150. The control unit is connected to the first imaging pixel array, the second imaging pixel array, the image processing unit, and the motion detection unit respectively. The image processing unit can use the Image Signal Process device (ISP) or Field Programmable Gate Array (FPGA). The motion detection unit can use the image signal processor (ISP) or Digital Signal Processor (DSP) or Field Programmable Gate Array (FPGA). The control unit is mainly used for controlling the first imaging pixel array, the second imaging pixel array, the image processing unit, the motion detection unit and the other corresponding circuits (such as the row decoder and column decoder) to work correctly, for outputting signals and for implementing various additional functions. The motion detection unit does the analysis, the calculation, and the format conversion of the signal outputted by the second imaging pixel array. The image processing unit does the format conversion of the signal outputted by the first imaging pixel array (such as transfer the RGB format to the YUV format), auto exposure control, auto balance control and etc. Finally, the motion detection unit outputs the motion signal; the image processing unit outputs the image signal. The execution module 160 receives the motion signal and the image signal and makes response, and processes the signal and controls the object on which the movements are executed carry out the corresponding activities.

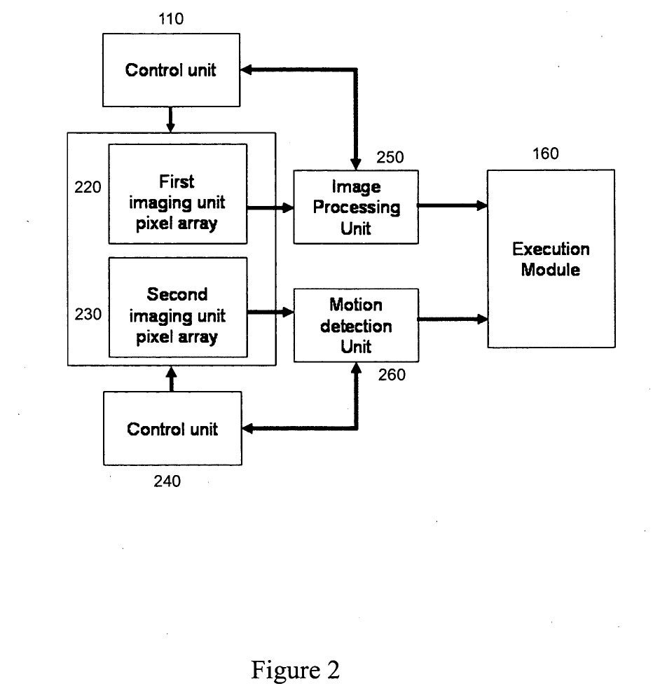

Please refer to FIG. 2, the difference between this embodiment and the first embodiment is as follows: the imaging module only comprises one imaging pixel array. The first imaging unit 220 and the second imaging unit 230 are all set in the imaging pixel array. Concretely, the imaging pixel array is divided into a first region used for capturing the image signal and a second region for capturing the motion signal of image and the motion signal of image device. The image processing unit 250 and the motion detection unit 260 are all connected to the imaging pixel array's signal output port. The control unit 240 is connected to the imaging pixel array, the image processing unit 250 and the motion detection unit 260 respectively, and controls the imaging pixel array, image processing unit 250, motion detection unit 260 and other related circuits to work normally.

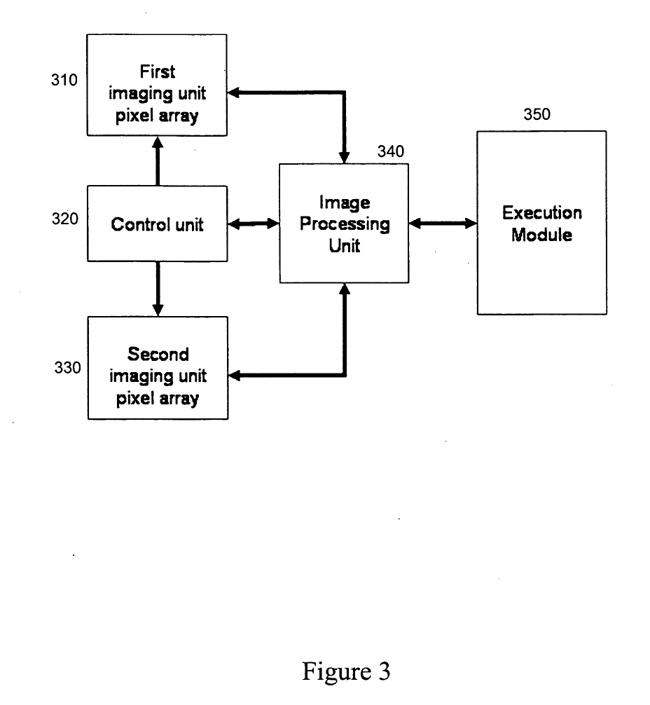

Please refer to FIG. 3, the difference between this embodiment and the first embodiment is as follows: the control unit 320 only comprises a processing unit 340. The control unit 320 is connected to the first imaging pixel array 310, the second imaging pixel array and the processing unit 340 respectively. The signal output port of the first and the second imaging pixel array are all connected to the processing unit 340. Finally, the processing unit outputs the motion signal and image signal, the execution module 350 responses to the motion signal and image signal.

As an improvement, the sampling frame rate of the first imaging unit 310 is lower than the sampling frame rate of the second imaging unit 330. As another improvement, the first imaging unit 310 and the second imaging unit 330 are set closely in the surface of the same imaging chip.

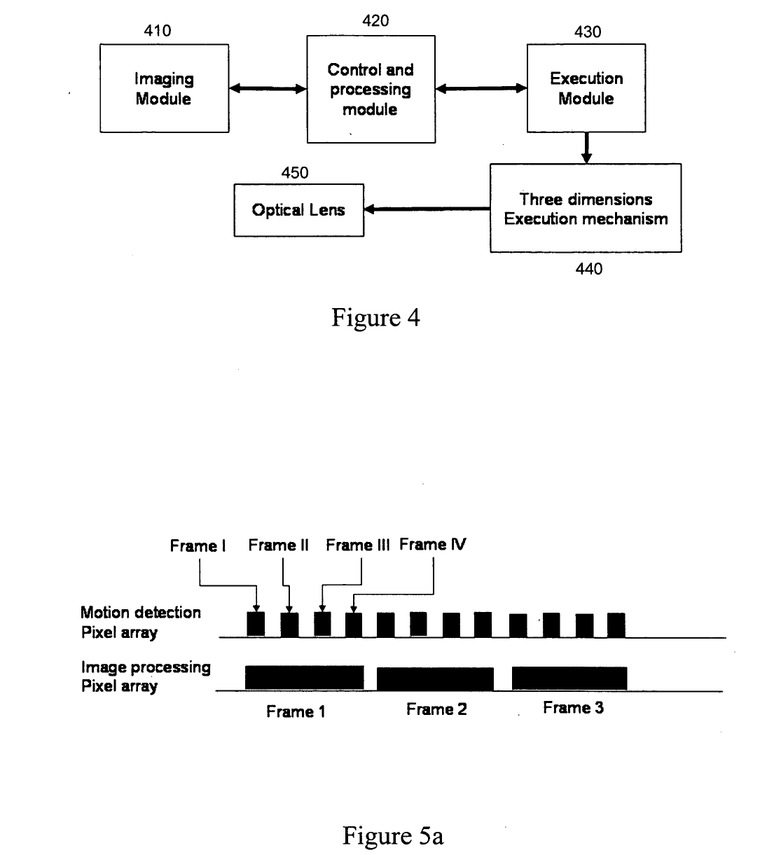

Please refer to FIG. 4, the image processing device comprises a imaging device and an execution module 430. The imaging device comprises a imaging module 410 and a processing module 420. The specific structure of the imaging device can use the above embodiment. The execution module 430 comprises an execution control unit and a three dimensions execution mechanism 440. The execution control unit sends out the motion control instruction according to the motion signal and image signal generated by the processing module, the three dimensions execution mechanism 440 drive the element being executed to move in three dimensions according to the motion control instruction. In an image capture device which uses the image processing device, the element being executed comprises the lens 450. According to the corresponding motion control instruction, the three dimensions execution mechanism 440 drives the lens unit 450 to move into the X, Y, Z directions to realize the anti-shake function.

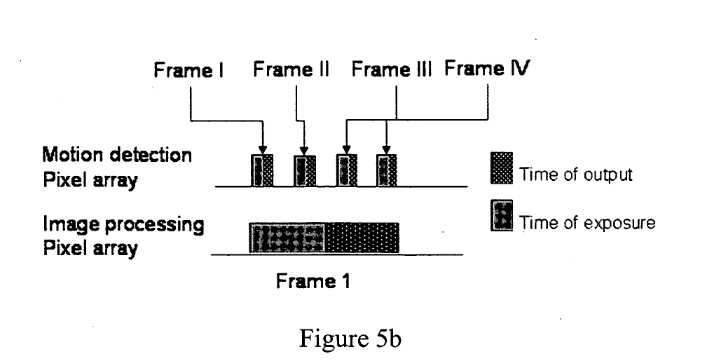

FIGS. 5a and 5b show the sub-frame detection principle of the invention. FIG. 5a shows one embodiment of the image capture device's video mode. FIG. 5b shows another embodiment of the image capture device's still image snapshot model. If the output frame rate of the imaging pixel array of the motion detection module is much faster than that of the image processing module, for example, the number of frame of the motion detection module is four while the image processing module only can output one frame within constant time interval, shown as FIG. 5. Through the analysis and processing of this four frame images the movement direction, displacement and etc of the imaging device or object can be obtained. The motion detection will be implemented. The element being executed compensates and corrects the image outputted by the pixel array.

In the embodiments of the invention, different imaging pixel arrays/regions can possess of different or same array size, pixel dot size, spectrum filtration method and other corresponding parameters. According to a possible element of a product, the first imaging unit and the second imaging unit may be configured appropriately and the image signal and motion signal will be obtained effectively accordingly. Comparing with the prior art, the embodiments of the invention comprise not only a imaging unit for capturing image, but also an imaging unit for motion detection. The imaging units accomplish the optical and electrical signal conversion. The imaging device then processes the electrical signal to obtain and output the motion signal and image signal. Embodiments of the invention can reflect the motion detection result more accurate than the prior art, and get higher detection precision. Comparing with the other solution of adopting other motion sensor devices, such as gyroscope and acceleration detection instruments, embodiments of the invention can simplify the device's configuration, and bring down the product's (such as the mobile phone's anti-shake image capture device) cost.

While embodiments of the invention have been described in terms of various specific embodiments, those skilled in the art will recognize that the invention can be practiced with modification with the spirit and scope of the claims.

What is claimed is:

1. An imaging device comprising:
an imaging module, used for optical to electrical signal conversion, which comprises at least one first imaging unit and one second imaging unit, wherein said first imaging unit used for capturing the image and the said second imaging unit used for detecting the movement of the image or said imaging device;
a control and processing module, used for controlling the said imaging module to output an electrical signal, and for processing the electrical signal to generate and to output a motion signal and an image signal.

2. An imaging device according to claim 1, wherein said first imaging unit comprises one imaging pixel array for capturing the image signal, and said second imaging unit comprises one or more imaging pixel sub-arrays; said imaging pixel sub-arrays are all used for capturing the motion signal, or all used for capturing the motion signal and the image signal simultaneously, or said second imaging unit comprises one second imaging pixel sub-array used for capturing the motion signal and another second imaging pixel sub-array used for capturing the motion signal and the image signal simultaneously.

3. An imaging device according to claim 1, wherein said first imaging unit and said second imaging unit are implemented in one imaging pixel array; and the imaging pixel array is divided into many regions, one region thereof is used for capturing the image signal, and other regions are used for capturing the motion signal, or all regions are used for capturing the motion signal and the image signal simultaneously; or the imaging pixel array comprises one region for capturing the motion signal and another region for capturing the motion signal and the image signal simultaneously.

4. An imaging device according to claim 1, wherein the said control and processing module comprises:
an image processing unit, used for processing the electrical signal outputted by said first imaging unit to generate the electrical signal of the image;
a motion detection unit, used for processing the electrical signal outputted by the said second imaging unit to generate the electrical signal of the motion; and
a control unit, used for controlling said first imaging unit, said second imaging unit, said image processing unit and said motion detection unit to work corporately.

5. An imaging device according to one of the claims 1-4, wherein said first imaging unit and said second imaging unit are set closely in the surface of the same imaging chip.

6. An imaging device according to one of the claims 1-4, wherein the sampling frame rate of said first imaging unit is lower than the sampling frame rate of said second imaging unit.

7. An imaging device according to one of the claims 1-4, wherein the pixel size and pixel amount of said first imaging unit and said second imaging unit is the same or different.

8. An image capturing device, comprises:
an imaging module, used for optical to electrical signal conversion, which at least comprises a first imaging unit and a second imaging unit, the second imaging unit is used for detecting the movement of the image or said image capture device, said first imaging unit is used for capturing an image;
a control and processing module, used for controlling said imaging module to output an electrical signal, processing the said electrical signal to generate and output a motion signal and an image signal;
a lens unit, used to produce an image of the photographed object at said imaging module; and
an execution module, used for executing said lens unit to carry out a relevant movement in response to the said motion signal and the image signal.

9. An image capture device according to claim 8, wherein the execution module comprises an execution control unit and a three dimensions execution mechanism, said execution control unit is used for sending out a motion control instruction according to the motion signal and image signal, said three dimensions execution mechanism is used for driving the object being executed to move in three dimensions according to the motion control instruction.

10. An image capture device according to claim 9, wherein the motion control instruction is the control instruction for controlling the movement of said lens unit to realize the anti-shake compensation.

11. An image capture device according to one of the claims 8-10, wherein said first imaging unit and said second imaging unit are set closely in the surface of the same imaging chip.

12. An image capture device according to one of the claims 8-10, wherein the sampling frame rate of said first imaging unit is lower than the sampling frame rate of said second imaging unit.

13. An image capture device according to one of the claims 8-10, wherein the pixel size and pixel amount of said first imaging unit and said second imaging unit is the same or different.
